(19) United States
(12) Patent Application Publication
(10) Pub. No.: US 2025/0391070 A1
(43) Pub. Date: Dec. 25, 2025

(54) CONDITION-BASED IMAGE EDITING

(71) Applicant: ADOBE INC., SAN JOSE, CA (US)

(72) Inventors: Qing Liu, Santa Clara, CA (US); Nannan Li, Brookline, MA (US); Jianming Zhang, Cupertino, CA (US); Krishna Kumar Singh, San Jose, CA (US); Yilin Wang, Sunnyvale, CA (US); Zhe Lin, Clyde Hill, WA (US)

(21) Appl. No.: 18/747,778

(22) Filed: Jun. 19, 2024

(51) Int. Cl. G06T 11/60; G06T 3/18; G06T 5/50; G06T 7/194; G06T 7/70; G06T 9/00

(52) U.S. Cl. CPC G06T 11/60; G06T 3/18; G06T 5/50; G06T 7/194; G06T 7/70; G06T 9/00; G06T 2207/20221

(57) ABSTRACT

A computer system and a computer-implement method include obtaining a source image and a modification input that indicates a target edit to the source image and generating a modification encoding representing the target edit. An image generation model generates an output image that depicts the source image with the target edit based on the source image and the modification encoding. The image generation model is trained to perform a pose modification task and a part replacement task.

### BACKGROUND

The following relates generally to image processing, and more specifically to human image editing. Image editing involves a multitude of different capabilities for manipulating and transforming images of people. There are distinct solutions for different image editing tasks.

Image editing, including human image editing, can be performed by using machine learning employing diffusion models. Diffusion models are a class of generative models that learn to reverse a diffusion process, gradually adding details to pure noise to produce high-quality images. Different diffusion models have been used separately for performing human image editing tasks.

### SUMMARY

A method, apparatus, and non-transitory computer readable medium for image processing are described. One or more aspects of the method, apparatus, and non-transitory computer readable medium include obtaining a source image and a modification input that indicates a target edit to the source image; generating a modification encoding representing the target edit; and generating, using an image generation model, an output image that depicts the source image with the target edit based on the source image and the modification encoding, wherein the image generation model is trained to perform a pose modification task and a part replacement task.

A method, apparatus, and non-transitory computer readable medium for training a machine learning model are described. One or more aspects of the method, apparatus, and non-transitory computer readable medium include obtaining a training set including a ground-truth image depicting an entity, pose information indicating a target pose of the entity, and a part image depicting a target part of the entity and training, using the training set, an image generation model to generate an output image that depicts the entity with the target pose and the target part.

An apparatus and method for image processing are described. One or more aspects of the apparatus and method include at least one processor; at least one memory storing instruction executable by the at least one processor; a part encoder comprising parameters stored in the at least one memory and trained to generate a part encoding based on a source image and a part image indicating a target part; a condition encoder comprising parameters stored in the at least one memory and trained to generate a condition encoding based on the source image and pose information indicating a target pose; and an image generation model comprising parameters stored in the at least one memory and trained to generate an output image that depicts an entity from the source image with the target pose or the target part based on the source image, the part encoding, and the condition encoding.

### BRIEF DESCRIPTION OF THE DRAWINGS

FIG. 1 shows an example of an image processing system according to aspects of the present disclosure.

FIG. 2 shows an example of an image processing application 200 according to aspects of the present disclosure.

FIG. 3 shows an example of a unified image processing system 300 according to aspects of the present disclosure.

FIG. 4 shows an example of an image processing method 400 according to aspects of the present disclosure.

FIG. 5 shows an example of an image processing apparatus 500 according to aspects of the present disclosure.

FIG. 6 shows an example of an image generation model 600 according to aspects of the present disclosure.

FIG. 7 shows an example of a method 700 for image processing according to aspects of the present disclosure.

FIG. 8 shows an example of a method 800 for training a machine learning model.

FIG. 9 shows an example of generated images 900 according to aspects of the present disclosure.

FIG. 10 shows an example of an image processing device 1000 according to aspects of the present disclosure.

### DETAILED DESCRIPTION

The following relates generally to image processing, and aspects relate more specifically to human image editing. Human image editing involves a multitude of different specific capabilities for manipulating and transforming images of people, including replacing image parts and changing the pose of a person in the image. Embodiments of the disclosure include an image generation model that accurately modifies both the parts and the pose of an image. In some embodiments, separate encoders generated separate guidance for part changes and pose changes, respectively. By training an image generation model on both part replacement and pose change tasks, the model outperforms models that have been trained for either task individually.

Different image generation models have been trained for individual tasks such as modifying the appearance and the pose of a person. While there are distinct challenges for different image editing objectives like pose manipulation, virtual try-on, and text-guided editing, these facets of human image editing are not disconnected.

Embodiments of the present disclosure improve conventional image generation models by more accurately generating images that include part changes or pose warping. The increased accuracy is achieved by training an image generation model on both of these tasks simultaneously. For example, by encoding this modification input as a condition and using a multi-task loss function during training, the model learns to generate high-fidelity output images that accurately reflect the specified edits. This enables the model to perform image editing accurately in diverse, real-world settings. For example, the model can take a source image of a person and a modification input specifying desired changes such as editing to a new pose, virtually trying on a different clothing style, or manipulating the image according to a text prompt describing the desired edits.

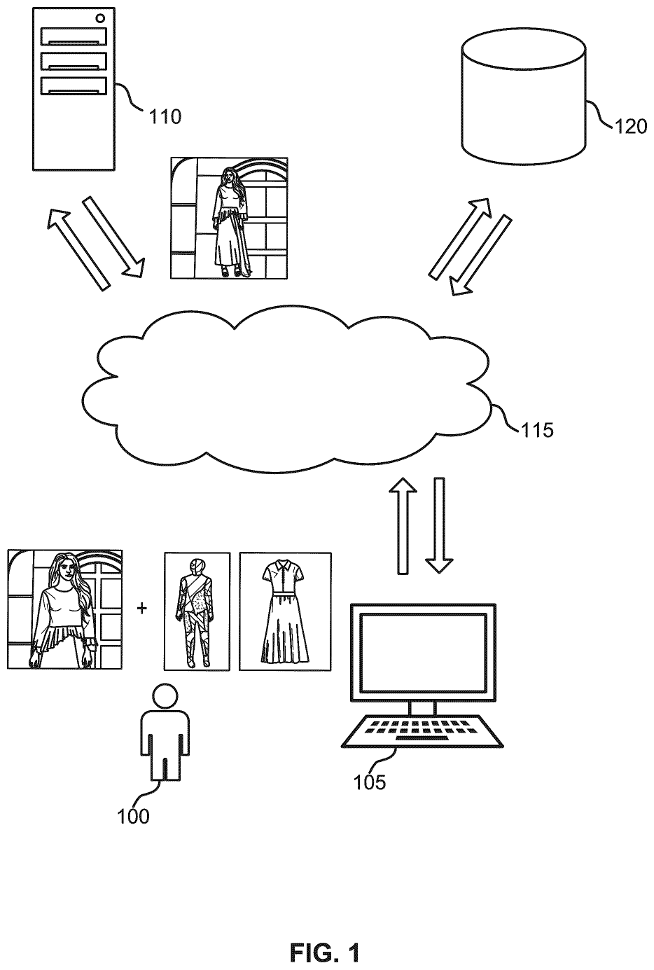

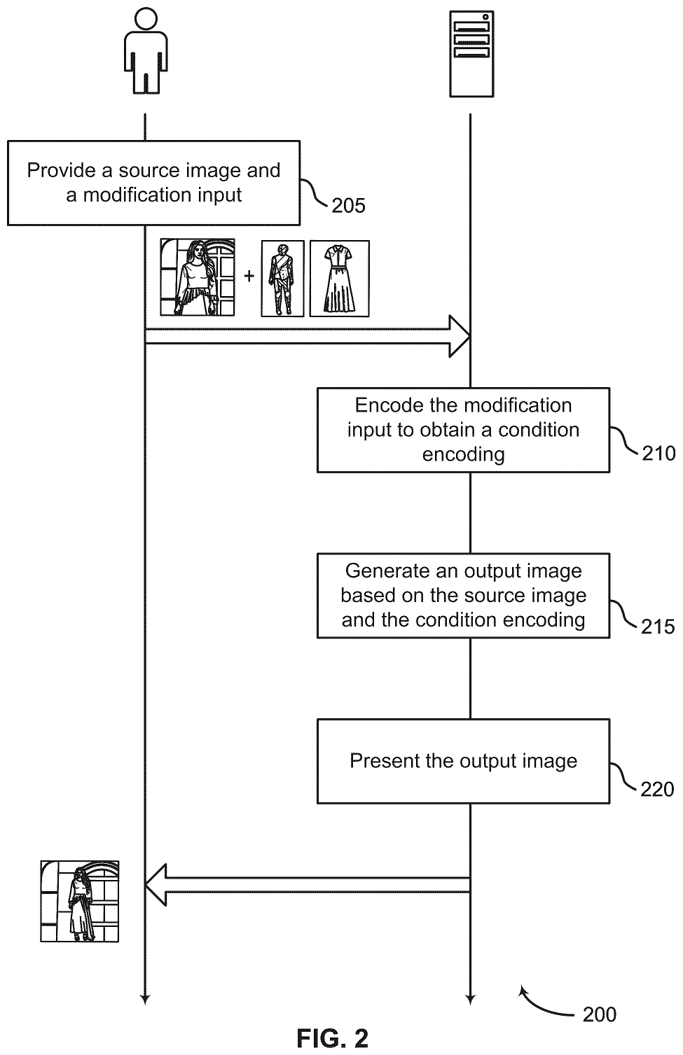

FIG. 1 shows an example of an image processing system according to aspects of the present disclosure. The image processing system is an example of, or includes aspects of, the corresponding element described with reference to FIGS. 2-5, and 10. The example shown includes user 100, user device 105, image processing apparatus 110, cloud 115, and database 120. Image processing apparatus 110 is an example of, or includes aspects of, the corresponding element described with reference to FIGS. 2-5, and 10.

In the example shown in FIG. 1, user 100 provides a source image and modification input to the image processing apparatus 110, e.g., via user device 105 and cloud 115. The source image depicts a woman with a background building, and the modification input includes a target edit including a target pose (full body and frontal) and a visual prompt (a women's dress). Image processing apparatus 110 then processes this input to generate an output image that accurately incorporates the desired modifications while preserving the identity and background consistency.

In this example, the image processing apparatus 110 employs multiple components, each designed to handle specific aspects of the image editing process. The part encoder component extracts relevant features from the source image and the visual prompt, capturing the texture and style information of the woman's body parts and the target dress. The pose-warping module generates a pose-warped texture by aligning the woman's appearance with the target pose. The condition encoder processes the target pose, pose-warped texture, and background information to provide guidance for the image generation process.

The encoded information from these components is then fed into the image generation model of the apparatus. This model takes the source image, part features, and condition encoding as inputs and generates an output image that depicts the woman from the source image in the target pose, wearing the dress specified by the visual prompt. The final output image is then returned to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIGS. 2-5, and 10.

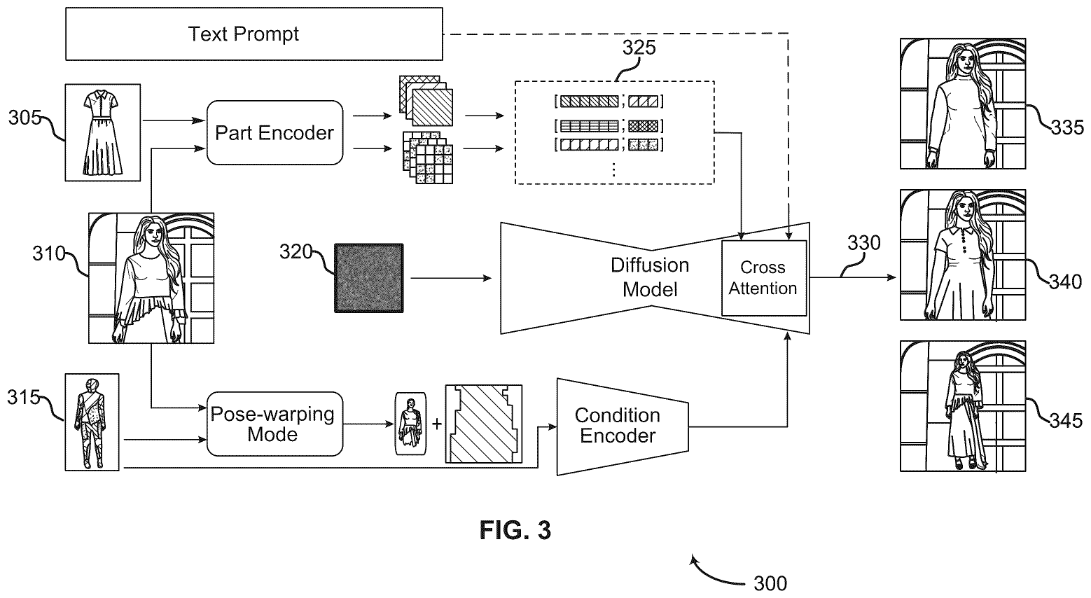

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 3-4, and 6. Further detail regarding the operation of image processing apparatus 110 is provided with reference to FIGS. 2-5, and 10.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image processing application 200 according to aspects of the present disclosure. The image processing application 200 is an example of, or includes aspects of, the corresponding element described with reference to FIGS. 1, 3-6, and 9-10.

At operation 205, the user provides a source image and a modification input to the system. The source image depicts an entity, such as a person, and the modification input indicates a target edit that specifies the desired changes to be made to the entity's appearance. The modification input can include a target edit that changes a target part of the entity, such as an article of clothing, a hair style, a makeup style, or a body art style. Additionally or alternatively, the modification input can include a target edit that indicates a target pose for the entity, specifying the desired position or orientation of the body parts.

At operation 210, the system encodes the modification input to obtain a condition encoding. This encoding process involves using a part encoder to extract relevant features from the source image and the modification input. The part encoder focuses on the target part specified by the modification input and generates a representation that captures the desired changes to that part. In some cases, the modification input indicates a target pose, and the system generates a pose-warped texture based on the source image and the target pose. The pose-warped texture represents the appearance of the entity's body parts and clothing when aligned with the desired pose.

In some cases, the system may select a pose-warping mode, such as dense warping or sparse warping, depending on the specific requirements of the task. In some cases, the system identifies the background portion of the source image and incorporates it into the condition encoding to ensure consistency in the generated output.

At operation 215, the system generates an output image based on the source image and the condition encoding obtained from the previous step. The output image depicts the entity from the source image with the modifications specified by the modification input. In some cases when the modification input includes a target part, such as an article of clothing, the output image may show the entity wearing that clothing item, generating a virtual try-on.

In some cases, the system uses an image generation model that takes the source image and the condition encoding as inputs and synthesizes a realistic output image. In some cases when a text prompt is provided to describe the target edit in natural language, the system encodes the text prompt to obtain a text encoding. The text encoding may be used as an additional input to guide the image generation process.

At operation 220, the system presents the generated output image to the user. The output image may depict the entity from the source image with the modifications applied according to the user's input. The modifications may include changes to specific parts of the entity, such as clothing items, hair style, makeup, or body art. In some cases, the output image may depict the entity in a different pose, as specified by the target pose in the modification input. In some examples, the background of the output image remains consistent with the source image.

FIG. 3 shows an example of a unified image processing system 300 according to aspects of the present disclosure. The unified image processing system 300 is an example of, or includes aspects of, the corresponding element described with reference to FIGS. 1, 2, 4-6, 9, and 10.

According to some embodiments, given a source image I_{src}, a target pose P_{tgt}, an optional visual prompt Gₜ and an optional text prompt y, a new image depicting the person of I_{src} at the target pose P_{tgt} may be generated according to embodiments of the present disclosure using an unified image processing system including an image generation model. In some cases, the unified image processing system simultaneously transfers the texture from visual prompt Gₜ and create a new texture based on text prompt y. In some embodiments, the unified image processing system includes more than one image editing tasks, for example, three human image editing tasks, such as a task of generating output images based on text manipulation, a task of generating virtual try-on images, and a task of generating reposing images.

In some cases, when a text prompt is provided, the unified image processing system may generate an output image based on the text prompt, via text manipulation. In some cases, in the absence of a visual prompt and a text prompt, the unified image processing system may perform the task of generating a human reposing image. In some cases, when the visual prompt is provided and specifies a target garment, the unified image processing system performs the task of generating virtual try-on images by transforming the visual prompt into virtual a try-on image.

According to some embodiments, the unified image processing system includes a part encoder, a pose-warping mode, and a condition encoder. The unified image processing system may be implemented using a diffusion model. The part encoder learns texture styles from segmented human parts, providing the texture styles information to cross-attention layers of the diffusion model. Simultaneously, the pose-warping mode generates target pose-aligned visible texture. These outputs, along with the target pose and partial background, may be used as input to the U-Net layers of the diffusion model via a condition encoder. For virtual try-on, the optional target garment is injected into the part encoder to be combined with other human parts. In some cases, the target garment is used to obtain a warped texture. In some examples, the warped texture is first encoded by the condition encoder, along with the target pose and partial background, to provide a comprehensive representation that guides the image generation process. The encoded warped texture is then injected into the U-Net through cross-attention, enabling the model to incorporate the detailed texture information of the target garment at different layers of the model. This cross-attention mechanism may enable the U-Net to effectively integrate the texture details with the other input information, such as the human parts and pose, to generate a consistent and realistic virtual try-on image. In cases of text manipulation, the U-Net layers of the diffusion model learn semantic information from an optional text prompt. After N-timestep denoising and VAE decoding, the unified image processing system produces a clean edited image.

According to some embodiments, to acquire texture information from the source person, a part encoder may be used to obtain segmented human part features. The segmented human part features are then fed into the U-Net layers of the diffusion model decoder. In some cases, unlike the approach where human parts are segmented at the pixel level and encoded separately, the part encoder of the unified image processing system segment parts at the feature level, i.e., take parts from the feature map of the entire source person. This segmented feature map may preserve more contextual information than image segments such as the length of the clothing and interactions between the upper and lower clothing.

In some examples, an off-the-shelf human parsing model may be used to extract face, hair, headwear, upper clothing, coat, lower clothing, shoes, accessories, and person from the source person's DINOv2 feature map. These visual features are then concatenated with the corresponding CLIP text embeddings. For example, let d_{ω} be the part encoder that includes DINOv2 and CLIP, the obtained part features B=d_{ω}(I_{src}) provides source texture and style information in the U-Net layers of the diffusion model.

According to some embodiments, to increase texture consistency after pose or garment change and increase the unified image processing system's ability to generalize to unseen textures, a pose-warping mode may be included in the unified image processing system. The pose-warping mode produces the pose-warped texture Iₜₑₓ and the binary mask Mᵥ. The pose-warped texture Iₜₑₓ and the binary mask Mᵥ are subsequently sent to the condition encoder and to the U-Net layers of the diffusion model cross-attention. Unlike methods that train task-specific pose warping modes, the unified image processing system obtains the pose-warped texture through explicit correspondence mapping. This process may involve using an off-the-shelf pose detector to provide sparse or dense pose prediction for texture warping, without relying on task-specific pose warping. Consequently, the unified image processing system is more resilient to domain shifts across different tasks, achieving enhanced generalization capacity to handle unseen patterns and styles.

According to some embodiments, for tasks involving human pose change, the pose-warped texture Iₜₑₓ₋ᵣₚ pertains to pixels that remain visible after reposing. The UV map correspondence to resample source RGB pixels may be used such that the UV coordinates are aligned with the target pose. This alignment enables direct reconstruction of intricate texture patterns. However, in cases where only the target garment requires repositioning, for example, in a task of generating virtual try-on images, 3D or contextual information is not provided from a target garment image, it may be unfeasible to warp the texture through UV coordinates. In these examples, the sparse key-points may be employed to apply a perspective warping from the canonical view of the target garment to the human torso. This warping repositions the clothing texture to the desired pose, providing the pose-warped texture Iₜₑₓ₋ᵥₜ for virtual try-on. For text manipulation, the pose-warped texture Iₜₑₓ₋ₜₘ exhibits adaptability, catering to user-specific requirements. For example, it can be set to zero to facilitate the generation of clothing textures from scratch based on the text input. Some experimental results demonstrate that the introduced pose-warped texture strengthens the generalization capacity of the unified image processing system.

According to some embodiments, the condition encoder takes the target pose P_{tgt}, pose-warped texture Iₜₑₓ and partial background I_{bg} as input, which provides essential posture guidance and visible texture reference for all tasks. The partial background image I_{bg} is extracted by masking out the bounding boxes of the source and target pose region. The encoded features in g_{ϕ} are concatenated with the intermediate features in U-Net layers of the diffusion model decoder as:

$${\hat{h}}^{i} = {W}_{h}^{i} [ {h}^{i} ; {g}_{ϕ}^{i} ( [ {I}_{tex} ; {P}_{tgt} ; {I}_{bg} ] ) ] , \qquad ( 1 )$$

where hⁱ is the i^{th} intermediate feature map of the U-Net layers of the diffusion model decoder,

$${g}_{ϕ}^{i}$$

is the i^{th} intermediate layer of g_{ϕ}.The intermediate layers of g_{ϕ} at varying resolutions are injected into blocks of the U-Net layers of the diffusion model decoder. E is defined as E=g_{ϕ}([Iₜₑₓ; ∅; ∅]), i.e., as the encoded pose-warped texture by itself in the last layer of g_{ϕ}, which will be sent to the U-Net layers of the diffusion model cross-attention described by Eq. (3) to further improve the texture quality.

According to some embodiments, reposing may be involved in the unified image processing system. The denoising process is guided by a target pose. The target pose may be enriched by textures from information of the source person. The texture information may be from the part features B and the pose-warped texture Iₜₑₓ. The part features B preserve style information, maintaining the overall authenticity of the generated clothing, and Iₜₑₓ provides detailed and spatial aligned textures, ensuring high fidelity in the generated image.

According to some embodiments, with B and Iₜₑₓ serving as the texture sources, the information of B and Iₜₑₓ may be transmitted by a cross-attention blocks of the layers of U-Net layers of the decoder of the diffusion model:

$$Attention ( Q , K , V ) = softmax ( {QK}^{T} ) \cdot V , \qquad ( 2 )$$

$${Q}^{i} = {W}_{Q}^{i} {h}^{i} , {K}^{i} = {W}_{K}^{i} [ B ; E ] , {V}^{i} = {W}_{V}^{i} [ B ; E ] , \qquad ( 3 )$$

where hⁱ is the i^{th} intermediate feature representation of U-Net layers of the diffusion model decoder.

$${W}_{Q}^{i} , {W}_{K}^{i} , {W}_{V}^{i}$$

are learnable weights. E indicates the encoded pose-warped texture in the condition encoder. In the following, Eᵣₚ, Eᵥₜ, Eₜₘ are used to denote the encoded pose-warped texture of each task.

According to some embodiments, with the diffusion model denoising function f_{θ}, the latent code for reposing

$${I}_{rp}^{( t )}$$

at time step t is obtained by:

$${I}_{rp}^{( t )} = {f}_{θ} ( {g}_{ϕ} ( [ {I}_{tex - rp} ; {P}_{tgt} ; {I}_{bg} ] ) , B , {E}_{rp} , {I}_{rp}^{( t + 1 )} , y ) , \qquad ( 4 )$$

where y is the optional text prompt that will also be mapped to the UNet decoder via the cross-attention block in diffusion model. This text cross-attention is applied after the part cross-attention in Eqs. (2) and (3).

In virtual try-on, the source garment Gₛ is first removed and then replaced by the target garment Gₜ in in the part features. Let I_{src}−Gₛ be the image without the source garment. The part features in virtual try-on thus becomes B′=[d_{ω}(I_{src}−Gₛ); d_{ω}(Gₜ)]. B′ is then utilized in denoising as:

$${I}_{vt}^{( t )} = {f}_{θ} ( {g}_{ϕ} ( [ {I}_{tex - vt} ; {P}_{src} ; {I}_{bg} ] ) , {B}^{′} , {E}_{vt} , {I}_{vt}^{( t + 1 )} , y ) , \qquad ( 5 )$$

where the source pose P_{src} is used as guidance since virtual try-on does not change the original posture of the person.

According to some embodiments, the unified image processing system may be used to edit the garment according to a text prompt. Similar to virtual try-on, the described source garment Gₛ is removed from the source image I_{src}, for which B′ is obtained. The garment's missing information will be replenished by the text cross-attention in diffusion model, resulting in the following denoising process:

$${I}_{tm}^{( t )} = {f}_{θ} ( {g}_{ϕ} ( [ {I}_{tex - tm} ; {P}_{src} ; {I}_{bg} ] ) , {B}^{′} , {E}_{tm} , {I}_{tm}^{( t + 1 )} , y ) \qquad ( 6 )$$

Referring to FIG. 3, the unified image processing system 300 may perform human image editing tasks including text manipulation, virtual try-on, and reposing. Depending on the task, the model generates one of three output images: a text manipulation image 335, a virtual try-on image 340, or a reposing image 345.

The system may take a source image 310, a visual prompt 305, and a target pose 315 as inputs. For example, the source image 310 depicts a person. The visual prompt 305 can be a garment image for virtual try-on, and the target pose 315 specifies the desired pose for reposing. According to some embodiments, when a different combination of one or more of the three inputs is provided, the system may perform a different task of the three tasks.

The part encoder processes the source image 310 and the visual prompt 305 (if provided) to extract part features 325, which capture the texture and style information of the person's body parts and garments. These part features 325 are then fed into the cross-attention blocks of the diffusion model's U-Net architecture.

Simultaneously, the pose-warping module may use the source image 310 and the target pose 315 as inputs to generate a pose-warped texture. This texture represents the visible regions of the person's body parts and garments after aligning them with the target pose 315. The pose-warped texture is then encoded by the condition encoder and fed into the U-Net at different resolutions.

The diffusion model also takes a noise latent code 320 as input. The noise latent code 320 is randomly initialized. For example, the denoising process 330 is performed iteratively. In this example, the U-Net receives the noise latent code 320, the part features 325 from the part encoder, the encoded pose-warped texture from the condition encoder, and an optional text prompt that describes the desired modifications.

During the denoising process 330, the cross-attention blocks in the U-Net attend to the part features 325 and the encoded pose-warped texture to guide the generation of the output image. The system learns to synthesize realistic textures and preserve the identity of the person while applying the desired modifications specified by the target pose 315, visual prompt 305, or text prompt.

In some examples, for the task of text manipulation, the system uses a text prompt to modify the person's appearance, such as changing the color or style of their clothing. In the case of virtual try-on, the visual prompt 305 such as a garment image is used to replace the person's original garment while preserving their pose and identity. For the task of reposing, the target pose 315 is used to guide the generation of an image where the person's pose is modified while keeping their appearance and garments intact.

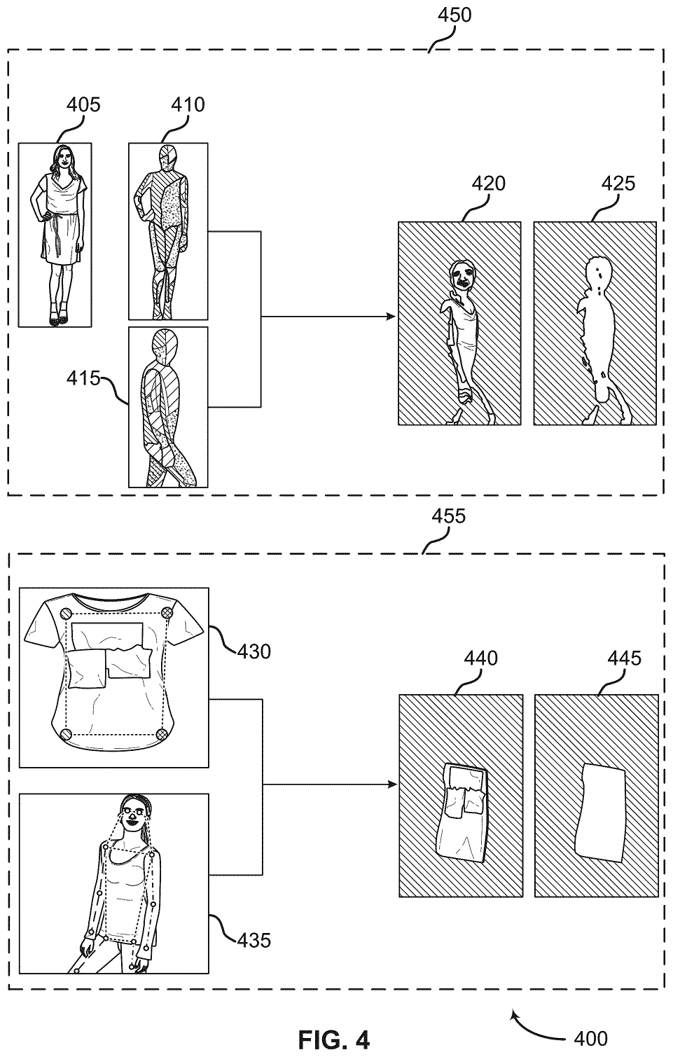

FIG. 4 illustrates the pose-warping processes 400 according to embodiments of the present disclosure. The pose-warping processes 400 are examples of, or include aspects of, the corresponding element described with reference to FIGS. 1-3, 5, 6, 9, and 10. According to some embodiments, the pose-warping processes 400 may be used to achieve texture consistency and generalization to textures in tasks such as reposing and virtual try-on.

Referring to FIG. 4, the pose-warping processes 400 include dense pose warping (reposing) 450 and sparse pose warping (virtual try-on) 455. In the dense pose warping (reposing) 450 process, the unified image processing system takes inputs including the source person 405, the source pose 410, and the target pose 415. The source person 405 is an image of a person in the person's original pose in the source image. The source pose 410 represents the keypoints or dense pose representation of the person in the source image. The target pose 415 specifies the desired pose for the output image.

The source person 405, the source pose 410, and the target pose 415 are then processed through a UV warping process. The UV warping process may utilize the correspondence between the source pose 410 and the target pose 415 to map the texture of the source person 405 onto the target pose 415. The output of the UV warping process includes a pose-warped texture 420 and a visibility mask 425. In some examples, the pose-warped texture 420 represents the visible regions of the person's clothing and body parts in the target pose 415. The visibility mask 425 may indicate the areas of the pose-warped texture 420 that are visible in the target pose 415.

As illustrated in FIG. 4, the sparse pose warping (virtual try-on) 455 process is used for changing the clothing of the person while keeping the person's pose unchanged. In these cases, the inputs are the target garment 430 and the target pose 435. The target garment 430 is an image of the clothing item to be tried on by the person. The target pose 435 represents the keypoints or sparse pose representation of the person in the source image. The target garment 430 and the target pose 435 are processed through a keypoint warping process.

The keypoint warping process uses the correspondence between the keypoints of the target garment 430 and the target pose 435 to map the texture of the target garment 430 onto the person's body. The output of the keypoint warping process is a pose-warped texture 440 and a visibility mask 445. The pose-warped texture 440 represents the target garment 430 aligned with the target pose 435. The visibility mask 445 indicates the areas of the pose-warped texture 440 that are visible on the person's body.

The pose-warped texture 420, the visibility mask 425, the pose-warped texture 440, and the visibility mask 445 are then passed to the condition encoder and the cross-attention blocks of the U-Net in the diffusion model. The condition encoder processes the pose-warped texture 420, the visibility mask 425, the pose-warped texture 440, and the visibility mask 445 to provide guidance for the denoising process. The guidance may be used to enable the generated output image to maintain the desired texture and appearance of the clothing and body parts.

In some examples, the cross-attention blocks use the pose-warped texture 420, the visibility mask 425, the pose-warped texture 440, and the visibility mask 445 to attend to the relevant regions of the input image during the denoising process. In these examples, attending to the relevant regions may enable the diffusion model to generate realistic and consistent output images for reposing and virtual try-on tasks.

According to embodiments of the present disclosure, an apparatus for image processing is described. One or more aspects of the apparatus include at least one processor; at least one memory storing instruction executable by the at least one processor; a part encoder comprising parameters stored in the at least one memory and trained to generate a part encoding based on a source image and a part image indicating a target part; a condition encoder comprising parameters stored in the at least one memory and trained to generate a condition encoding based on the source image and pose information indicating a target pose; and an image generation model comprising parameters stored in the at least one memory and trained to generate an output image that depicts an entity from the source image with the target pose or the target part based on the source image, the part encoding, and the condition encoding.

Some examples of the apparatus and method further include a pose-warping mode configured to generate a pose-warped texture based on the source image and the pose information. Some examples of the apparatus and method further include a text encoder configured to generate a text encoding based on a text prompt. Some examples of the apparatus and method further include a pose detector configured to generate the pose information based on the source image. Some examples of the apparatus and method further include a segmentation model configured to generate the part image based on the source image.

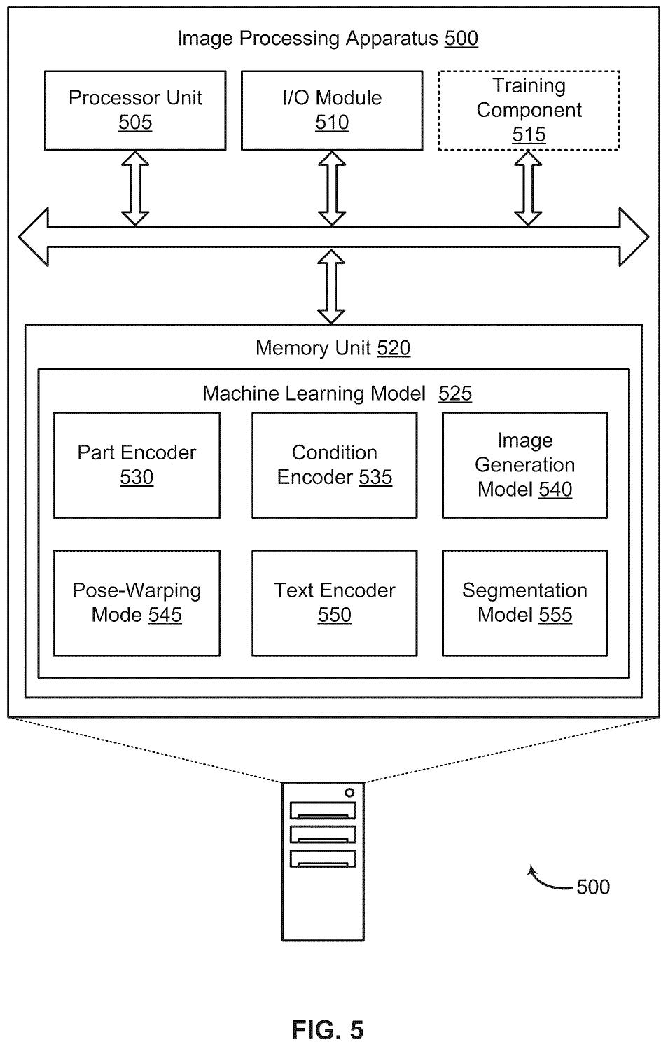

FIG. 5 shows an example of an image processing apparatus 500 according to aspects of the present disclosure. The image processing apparatus 500 is an example of, or includes aspects of, the corresponding element described with reference to FIGS. 1-4, 7-8, and 10. In one aspect, image processing apparatus 500 includes processor unit 505, I/O module 510, training component 515, memory unit 520, and machine learning model 525. Machine learning model 525 includes part encoder 530, condition encoder 535, image generation model 540, pose-warping mode 545, text encoder 550, segmentation model 555.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

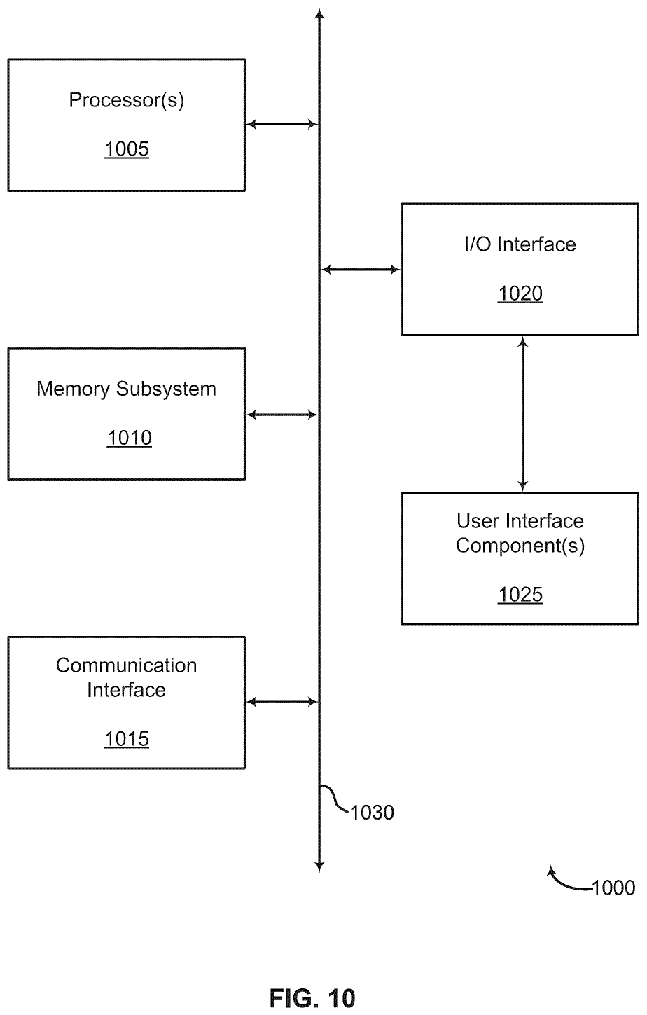

In some cases, processor unit 505 is configured to operate a memory array using a memory controller. In other cases, a memory controller is integrated into processor unit 505. In some cases, processor unit 505 is configured to execute computer-readable instructions stored in memory unit 520 to perform various functions. In some aspects, processor unit 505 includes special purpose components for modem processing, baseband processing, digital signal processing, or transmission processing. According to aspects, processor unit 505 comprises one or more processors described with reference to FIG. 10.

Memory unit 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 520 includes a basic input/output system (BIOS) that controls basic hardware or software operations, such as an interaction with peripheral components or devices. In some cases, memory unit 520 includes a memory controller that operates memory cells of memory unit 520. For example, the memory controller may include a row decoder, column decoder, or both. In some cases, memory cells within memory unit 520 store information in the form of a logical state. According to aspects, memory unit 520 comprises the memory subsystem described with reference to FIGS. 1-4, 7-8, and 10.

According to aspects, image generation apparatus 500 uses one or more processors of processor unit 505 to execute instructions stored in memory unit 520 to perform functions described herein. For example, in some cases, the image generation apparatus 500 obtains a prompt describing an image element. For example, the image element may correspond to a plurality of concepts.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Referring to FIG. 5, machine learning model 525 includes part encoder 530, condition encoder 535, image generation model 540, pose-warping mode 545, text encoder 550, segmentation model 555. Part encoder 530 processes the source image and the optional visual prompt, for example, target garment image, to extract relevant features and generate part features. The part features capture the texture and style information of the person's body parts and garments in the source image and the target garment image. Condition encoder 535 takes the target pose, pose-warped texture, and partial background as input and generates a condition encoding. The condition encoding provides guidance for the image generation process, ensuring that the generated output image accurately incorporates the desired pose, texture, and background information.

Image generation model 540 takes the source image, part features from the part encoder 530, and condition encoding from the condition encoder 535 as inputs. Image generation model 540 can generate the output image that depicts the person from the source image with the desired modifications, such as the target pose, target garment, or text-guided edits. The image generation model 540 uses a multi-task loss function during training to ensure the generated image accurately preserves the identity and characteristics of the person while incorporating the desired modifications.

Pose-warping module 545 generates the pose-warped texture based on the source image and the target pose. Pose-warping module 545 may use dense correspondence mapping for reposing tasks and keypoint-based warping for virtual try-on tasks. For example, the pose-warped texture may represent the appearance of the person's body parts and garments when aligned with the target pose, providing important guidance for the image generation process.

Text encoder 550 processes the optional text prompt that describes the desired modifications to the person's appearance. Text encoder 550 generates a text encoding that captures the semantic information provided by the text prompt, allowing the image generation model 540 to incorporate the text-guided modifications into the output image. Segmentation model 555 generates the part segmentation maps from the ground-truth images. The generated part segmentation maps are used to compute the entity-part loss term in the multi-task loss function.

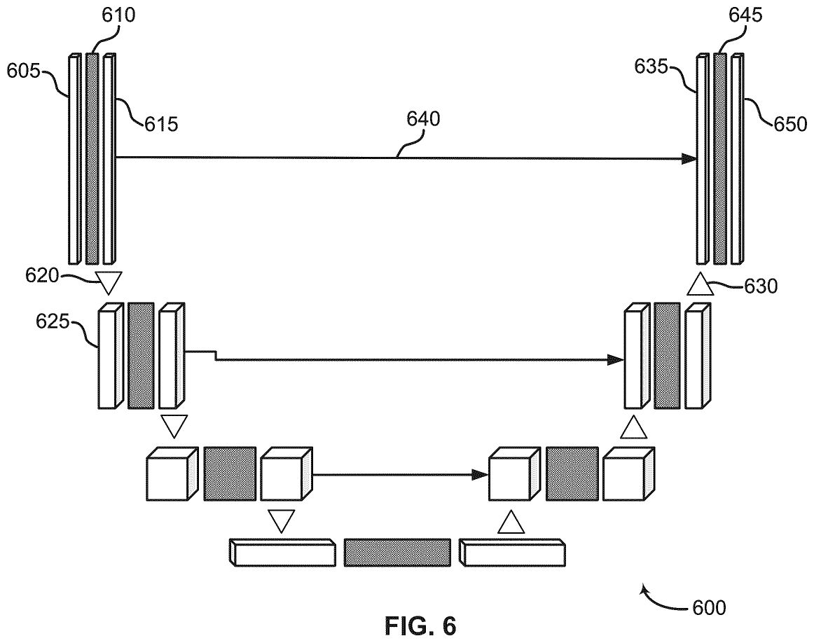

FIG. 6 shows an example of an image processing model 600 according to aspects of the present disclosure. The image processing model 600 is an example of, or includes aspects of, the corresponding element described with reference to FIGS. 1-5, 9, and 10. According to some aspects, image generation model 600 comprises a diffusion model including an ANN architecture such as a U-Net.

According to some aspects, image generation model 600 receives input features 605, where input features 605 include an initial resolution and an initial number of channels, and processes input features 605 using an initial neural network layer 610 (e.g., a convolutional neural network layer) to produce intermediate features 615. In some cases, intermediate features 615 are then down-sampled using a down-sampling layer 620 such that down-sampled features 625 have a resolution less than the initial resolution and a number of channels greater than the initial number of channels.

In some cases, this process is repeated multiple times, and then the process is reversed. For example, down-sampled features 625 are up-sampled using up-sampling process 630 to obtain up-sampled features 635. In some cases, up-sampled features 635 are combined with intermediate features 615 having the same resolution and number of channels via skip connection 640. In some cases, the combination of intermediate features 615 and up-sampled features 635 are processed using final neural network layer 645 to produce output features 650. In some cases, output features 650 have the same resolution as the initial resolution and the same number of channels as the initial number of channels.

According to some aspects, image generation model 600 receives additional input features to produce a conditionally generated output. In some cases, the additional input features include a vector representation of an input prompt. In some cases, the additional input features are combined with intermediate features 615 within Image generation model 600 at one or more layers. For example, in some cases, a cross-attention module is used to combine the additional input features and intermediate features 615.

According to embodiments of the present disclosure, a method, apparatus, and non-transitory computer readable medium for training a machine learning model are described. One or more aspects of the method include obtaining a training set including a ground-truth image depicting an entity, pose information indicating a target pose of the entity, and a part image depicting a target part of the entity and training, using the training set, an image generation model to generate an output image that depicts the entity with the target pose and the target part.

Some examples of the method, apparatus, and non-transitory computer readable medium for training a machine learning model comprise computing a multi-task loss function including an entity-part loss term and a pose-warp loss term; and updating parameters of the image generation model based on the multi-task loss function. The entity-part loss term corresponds to a part replacement task and the pose-warp loss term corresponds to a pose modification task.

In some aspects, the entity-part loss term is based on a segmentation map for the target part of the entity. In some aspects, the pose-warp loss term is based on a visibility map corresponding to the target pose of the entity. In some aspects, the multi-task loss function includes a diffusion loss term. Some examples of the method for training a machine learning model comprises obtaining the training set comprises applying a pose detection model to the ground-truth image to the pose information. Some examples of the method, apparatus, and non-transitory computer readable medium for training a machine learning model further include obtaining the training set comprises applying a segmentation model to the ground-truth image to obtain the part image. In some cases, obtaining a training set can include creating training samples for training the machine learning model.

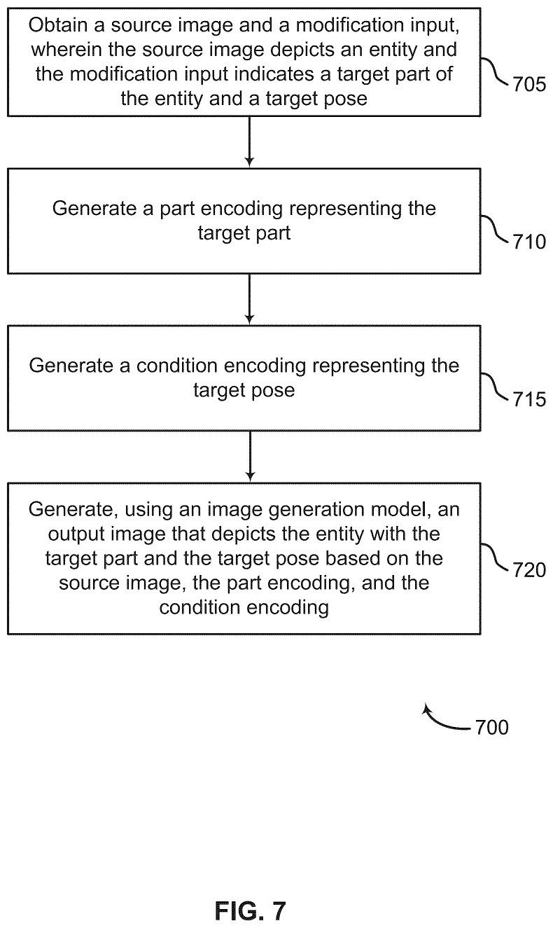

FIG. 7 shows an example of a method 700 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains a source image and a modification input, wherein the source image depicts an entity and the modification input indicates a target part of the entity and a target pose. In some cases, the operations of this step refer to, or may be performed by, an image generation model as described with reference to FIGS. 1, 5-6 and 10.

For example, at operation 705, the system obtains a source image and a modification input. The source image depicts an entity, such as a person, an animal, or an object. The modification input indicates a desired modification to be applied to the entity in the source image. The modification input may take one or more forms, depending on the specific implementation and the type of modification desired.

In some examples, the modification input may specify a target part of the entity to be modified, such as an article of clothing, a hair style, a makeup style, or a body art style. In some examples, the modification input may include an image or a description of the target part, indicating how the corresponding part of the entity should be changed in the output image.

In some examples, the modification input may indicate a target part of the entity and a target pose. In some examples, the modification input may indicate a target part of the entity and a target pose. For example, the target part specifies a particular component or region of the entity that needs to be modified, such as an article of clothing, a hairstyle, or a facial feature. For example, the target pose specifies the desired position or orientation of the entity's body parts, such as the overall body posture or the arrangement of limbs. The modification input may include keypoints, landmarks, or other representations that define the target pose or expression. In some examples, the modification input may include a text description of the desired modification.

Depending on the nature of the modification input, at least one of operations 710 and 715 may be performed. For example, if the modification input indicates a target edit including a part replacement, a part encoding may be generated according to operation 710. Additionally or alternatively, if the modification input includes a pose change, a condition encoding representing the pose change can be generated according to operation 715.

At operation 710, the system generates a part encoding representing the target part. In some cases, the operations of this step refer to, or may be performed by, a part encoder as described with reference to FIGS. 1, 5-6, and 10.

In some examples, the encoding process may involve various techniques, depending on the type of modification input and the architecture of the image generation model. For example, if the modification input specifies a target part, the system may use a part encoder to extract relevant features from the target part image or description. The part encoder may employ architectures to learn representations of the target part. In some examples, when the modification input involves a target pose, the system may generate a pose-warped texture based on the source image and the target pose.

In some examples, the system may use techniques like dense correspondence mapping or keypoint-based transformations. Dense correspondence mapping may generate a pixel-wise alignment between the source and target poses, and keypoint-based methods may use a set of corresponding key points to guide the warping process. In some examples, the system may employ a condition encoder to incorporate additional context into the condition encoding. The condition encoder may process information such as the background of the source image, the spatial arrangement of entity parts, or the global scene context.

At operation 715, the system generates a condition encoding representing the target pose. In some cases, the operations of this step refer to, or may be performed by, a condition encoder as described with reference to FIGS. 1, 5-6, and 10.

In some examples, at operation 715, the system takes the target pose as input and processes it to create a condition encoding. The target pose may be a representation of the desired position, orientation, or configuration of the entity's body parts. In some examples, the system then uses a condition encoder to generate a representation of the target pose. The representation of the target pose may be referred to as the condition encoding. The condition encoder can be a neural network or another type of machine learning model that is trained to extract relevant features and patterns from the input pose data.

In some examples, the condition encoding captures the spatial and structural information of the target pose in a way that can be effectively used by the subsequent stages of the image generation process. This encoding may guide the image generation model to synthesize an output image that accurately depicts the entity in the desired pose.

At operation 720, the system generates, using an image generation model, an output image that depicts the entity with the target part and the target pose based on the source image, the part encoding, and the condition encoding. The system uses an image generation model to create an output image that depicts the entity from the source image with the desired modifications specified by the target part and the target pose. The image generation model may take one or more of three inputs including the source image, the part encoding, and the condition encoding. In some examples, the part encoding, obtained from the part encoder, provides information about the appearance and style of the target part. In some examples, the condition encoding, generated by the condition encoder, captures the spatial and structural information of the target pose.

In some examples, the image generation model may be trained using a multi-task loss function. The multi-task loss function includes an entity-part loss term (i.e., for part replacement), a pose-warp loss term (i.e., for pose modification), and a diffusion training loss term. In some cases the diffusion training loss term is a reconstruction loss that measures the difference between the generated image and the ground-truth image. In some cases, the operations of this step refer to, or may be performed by, an image generation model as described with reference to FIGS. 1, 5-6, and 10.

In some examples, the image generation model can be implemented based on a diffusion model architecture including a U-Net as illustrated in FIG. 6. For example, during the image generation process, the model preserves the identity and characteristics of the entity that are not being modified, while applying the desired modifications to the target parts or poses. A multi-task loss function that includes an entity-part loss term and a pose-warp loss term may be used to train the image generation model in a unified manner.

In some examples, the entity-part loss term encourages the model to maintain the appearance of the entity's parts that are not being modified. The entity-part loss term may be used to train the model to generate output images that retain the recognizable features and attributes of the original entity, such as facial features, body shape, or clothing style.

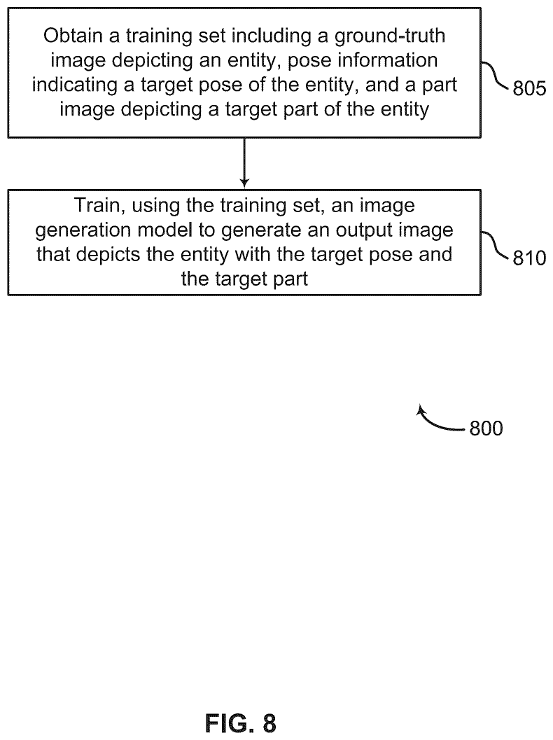

In some examples, the pose-warp loss term focuses on the accuracy of the modified parts or poses. The pose-warp loss term may guide the model to generate an output image where the modified parts or poses are correctly aligned and integrated with the rest of the entity's appearance. Training of the image generation model will be further discussed with reference to FIG. 8.

FIG. 8 shows an example of a method 800 for training a machine learning model. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to some embodiments, two loss functions may be used to constrain the cross attention for different human parts and pose-warped texture. For each human part pₙ, let Aₚ_{ₙ} and Mₚ_{ₙ} be the attention map of Bₚ_{ₙ} and segmentation map (resized to the same size), respectively. Their distance be minimized by:

$${ℒ}_{B} = {\sum }_{n} ( mean ( {A}_{{p}_{n}} ⊙ ( 1 - {M}_{{p}_{n}} ) ) - mean ( {A}_{{p}_{n}} ⊙ {M}_{{p}_{n}} ) ) , \qquad ( 7 )$$

Similarly, for the pose-warped texture, using the binary visibility map obtained, the attention map of E may be constrained by:

$${ℒ}_{E} = mean ( {A}_{v} ⊙ ( 1 - {M}_{v} ) ) - mean ( {A}_{v} ⊙ {M}_{v} ) \qquad ( 8 )$$

Driven by the two losses, the model may be steered towards sampling from the pose-warped textures for visible pixels, and from part features for invisible regions. The net result is a harmonious interplay that ensures accurate reconstruction and optimized fidelity for the entire generated content. For a diffusion model training loss, the U-Net may predict a noise ϵ_{θ} given the noisy version of the target image

$${I}_{tgt}^{( t )}$$

at each time step t. Let ϵ be the ground-truth noise and the L2 loss function is simplified as

$${ℒ}_{SD} = {𝔼}_{{I}_{tgt} , ϵ ∼ 𝒩 ( 0 , 1 ) . t} {‖ ϵ - {ϵ}_{θ} ( {I}_{tgt}^{( t )} , t , … ) ‖}_{2}^{2} , \qquad ( 9 )$$

where . . . in the equation omits other conditional inputs in the model, including B, P_{tgt} (or P_{src}), I_{bg}, Iₜₑₓ and y. In summary, the overall objective function of the model is [symbol] = [symbol] _{SD}+λ₁ [symbol] _{B}+λ₂ [symbol] _{E}, where λ₁ and λ₂ are trade-off parameters.

Some datasets for human image editing exhibit limitations in scale and diversity because many of these images are in-studio photography with fashion models. This results in images with simple indoor backgrounds and younger age groups. Embodiments of the present disclosure include curating a larger-scale training dataset with augmented diversity. In some cases, creating a training set can include obtaining a preexisting set of training data for training the machine learning model. In some cases, obtaining a training set can include creating training samples for training the machine learning model.

Referring to FIG. 8, at operation 805, the system obtains a training set including a ground-truth image depicting an entity, pose information indicating a target pose of the entity, and a part image depicting a target part of the entity. In some cases, the operations of this step refer to, or may be performed by, a training component as described with reference to FIGS. 1, 5-6, and 10.

In some examples, the pose information indicates the target pose of the entity in the ground-truth image. The pose information may specify the desired position, orientation, or configuration of the entity's body parts or components.

In some examples, the part image focuses on a specific target part of the entity such as the person. The part image may provide a detailed representation or segmentation of that particular part, such as a clothing item, or a body part. The part image may be used for the model to learn the appearance and characteristics of the target part.

To obtain the training set, the system may employ various techniques and models. For example, the system may apply a pose detection model to the ground-truth image to estimate the pose information. Pose detection models may analyze the ground-truth image including an entity and predict the locations and orientations of the entity's body parts or key points.

At operation 810, the system trains, using the training set, an image generation model to generate an output image that depicts the entity with the target pose and the target part. In some cases, the operations of this step refer to, or may be performed by, a training component as described with reference to FIGS. 1, 5-6, and 10. At operation 810, the system trains the image generation model using the obtained training set. The goal is to train the model to generate an output image that depicts the entity with the target pose and the target part, as specified in the training set.

In some examples, the image generation model learns to map the input source image and the condition encoding, which encodes the desired modifications, to the corresponding ground-truth image. The model adjusts its internal parameters to minimize the difference between the generated output image and the ground-truth image.

In some examples, to guide the training process and ensure accurate pose and part modifications, the system employs a multi-task loss function. The multi-task loss function includes the entity-part loss term, the pose-warp loss term, and the diffusion model training loss term.

The entity-part loss term focuses on training the model to attend to the relevant parts of the entity during the generation process. The entity-part loss term minimizes the distance between the attention map of each human part and its corresponding segmentation map. By encouraging the attention map to match the segmentation map, this loss term helps the model generate accurate and detailed target parts in the output image.

The pose-warp loss term focuses on training the model to maintain texture consistency and fidelity when warping the pose of the entity. The pose-warp loss term constrains the attention map of the pose-warped texture to match the visibility map obtained from the target pose. In some examples, by minimizing the difference between the attention map and the visibility map, the pose-warp loss term guides the model to generate coherent and well-aligned output images, preserving the visible textures while accurately synthesizing the invisible regions.

In some cases, the diffusion model training loss term may be a reconstruction loss that measures the difference between the generated image and the ground-truth image. The diffusion model training loss term focuses on the L2 distance between the predicted noise and the ground-truth noise at each time step of the diffusion process. The multi-task loss function is a weighted combination of these loss terms, with trade-off parameters that control the relative importance of each term.

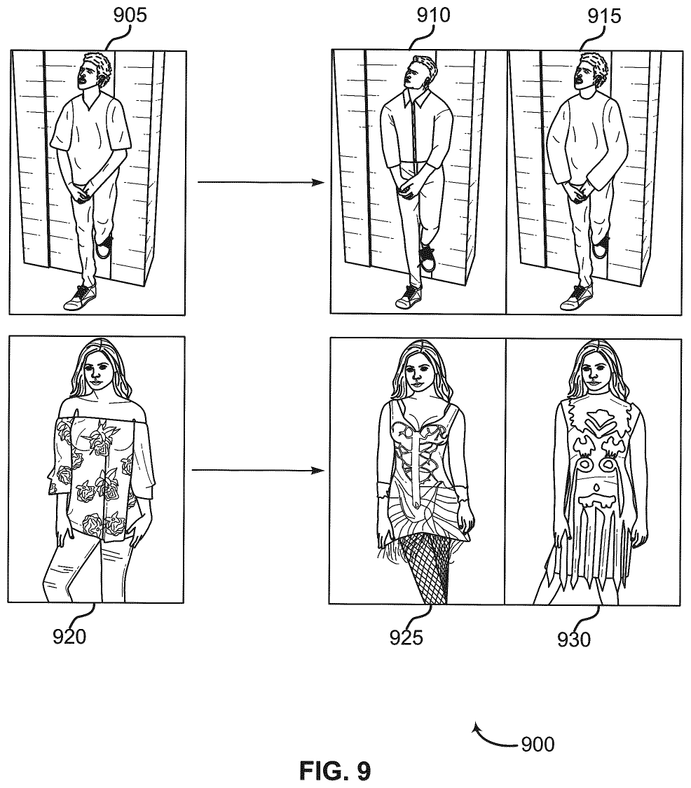

FIG. 9 shows an example of generated images 900 according to aspects of the present disclosure. The examples 900 are examples of, or includes aspects of, the corresponding element described with reference to FIGS. 1-6, and 10. FIG. 9 illustrates the superior quality of the images generated by the present invention compared to other methods.

In the first row, the first input image 905 depicts a person and is accompanied by the text “Long Sleeved Blouse,” indicating the desired modification to the person's clothing. As illustrated in FIG. 9, the first low-quality image 910, generated by an alternative method, fails to accurately incorporate the long-sleeved blouse feature. In contrast, the first high-quality image 915, generated by the present invention, depicts the person wearing a long-sleeved blouse.

In the second row, the second input image 920 shows a person and is accompanied by the text “Halloween Costume,” specifying the desired modification to the person's appearance. The second low-quality image 925, generated by an alternative method, fails to accurately portray the person wearing a Halloween costume. In contrast, the second high-quality image 930, generated according to embodiments of the present disclosure, depicts the person in a Halloween costume.

The comparison between the images generated by some alternative method and the high-quality images generated according to embodiments of the present disclosure. Examples 900 demonstrate the superior performance of the model in generating images that accurately reflect the desired modifications specified by the input text in the field of human image editing.

FIG. 10 shows an example of a computing device 1000 according to aspects of the present disclosure. The computing device 1000 is an example of, or includes aspects of, the corresponding element described with reference to FIGS. 1-6, and 9.

The computing device 1000 includes processor(s) 1005, memory subsystem 1010, communication interface 1015, I/O interface 1020, user interface component(s) 1025, and channel 1030. In some embodiments, computing device 1000 includes one or more processors 1005 that can execute instructions stored in memory subsystem 1010 to generate synthetic images comprising a first attribute and a second attribute by providing a first attribute token to a first set layers of the image generation model during a first set of time-steps and providing a second attribute token to a second set of layers of the image generation model during a second set of time-steps

According to some aspects, computing device 1000 includes one or more processors 1005. Processor(s) 1005 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1010 includes one or more memory devices. Memory subsystem 1010 is an example of, or includes aspects of, the memory unit as described with reference to FIGS. 1-5, and 8. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component 1025 enables a user to interact with computing device 1000. In some cases, user interface component 1025 includes an audio device, such as an external speaker system, an external display device such as a display screen, an input device (e.g., a remote-control device interfaced with a user interface directly or through the I/O controller), or a combination thereof. In some cases, user interface component 1025 includes a GUI.

According to embodiments of the present disclosure, a method for image processing is described. One or more aspects of the method include obtaining a source image and a modification input, wherein the source image depicts an entity and the modification input indicates a target part of the entity and a target pose; generating a condition encoding representing the target pose; and generating, using an image generation model, an output image that depicts the entity with the modification based on the source image and the condition encoding, where the image generation model is trained using a multi-task loss function including an entity-part loss term and a pose-warp loss term.

Some examples of the method, apparatus, and non-transitory computer readable medium further include encoding, using a part encoder, the modification input based on the source image to obtain the condition encoding, wherein the modification input indicates a target part of the entity and a target pose. Some examples of the method, apparatus, and non-transitory computer readable medium further include encoding the modification input comprises generating a pose-warped texture based on the source image and the modification input, wherein the modification input indicates a target pose of the entity. Some examples of the method, apparatus, and non-transitory computer readable medium further include encoding the modification input comprises generating, using a condition encoder, condition encoding based on the target pose and the pose-warped texture.

Some examples of the method, apparatus, and non-transitory computer readable medium further include selecting a pose-warping mode from a set of pose-warping modes including a dense warping mode and a sparse warping mode, wherein the pose-warped texture is generated based on the selected pose-warping mode. Some examples of the method, apparatus, and non-transitory computer readable medium further include identifying a background portion of the source image, wherein the condition encoding is generated based on the background portion.

Some examples of the method, apparatus, and non-transitory computer readable medium further include obtaining a text prompt describing the target edit. Some examples further include encoding the text prompt to obtain a text encoding, wherein the output image is generated based on the text encoding. In some aspects, the modification input comprises a target part comprising an article of clothing, a hair style, a makeup style, or a body art style, and wherein the output image comprises a virtual try-on of the target part on the entity.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a source image and a modification input that indicates a target edit to the source image;
generating a modification encoding representing the target edit; and
generating, using an image generation model, an output image that depicts the source image with the target edit based on the source image and the modification encoding, wherein the image generation model is trained to perform a pose modification task and a part replacement task.

2. The method of claim 1, wherein generating the modification encoding comprises:
encoding an image depicting a target replacement element for an element of the source image.

3. The method of claim 1, wherein generating the modification encoding comprises:
generating a pose-warped texture based on the source image and the modification input, wherein the modification encoding is based on the pose-warped texture.

4. The method of claim 3, further comprising:
selecting a mode from a set of pose-warping modes including a dense warping mode and a sparse warping mode, wherein the pose-warped texture is generated based on the selected mode.

5. The method of claim 1, further comprising:
identifying a background portion of the source image, wherein the modification encoding is generated based on the background portion.

6. The method of claim 1, further comprising:
obtaining a text prompt describing the target edit; and
encoding the text prompt to obtain a text encoding, wherein the output image is generated based on the text encoding.

7. The method of claim 1, wherein:
the target edit comprises a replacement of at least one of an article of clothing, a hair style, a makeup style, or a body art style, and wherein the output image comprises a virtual try-on based on the replacement.

8. The method of claim 1, wherein:
the modification input comprises at least one of a part replacement input or a pose modification.

9. A method for training a machine learning model, the method comprising:
obtaining a training set including a ground-truth image depicting an entity, pose information indicating a target pose of the entity, and a part image depicting a target part of the entity; and
training, using the training set, an image generation model to generate an output image that depicts the entity with the target pose and the target part.

10. The method of claim 9, wherein training the image generation model comprises:
computing a multi-task loss function including an entity-part loss term and a pose-warp loss term; and
updating parameters of the image generation model based on the multi-task loss function.

11. The method of claim 10, wherein:
the entity-part loss term is based on a segmentation map for the target part of the entity.

12. The method of claim 10, wherein:
the pose-warp loss term is based on a visibility map corresponding to the target pose of the entity.

13. The method of claim 10, wherein:
the multi-task loss function includes a diffusion loss term.

14. The method of claim 9, wherein obtaining the training set comprises:
applying a pose detection model to the ground-truth image to the pose information.

15. The method of claim 9, wherein obtaining the training set comprises:
applying a segmentation model to the ground-truth image to obtain the part image.

16. An apparatus comprising:
at least one processor;
at least one memory storing instruction executable by the at least one processor;
a part encoder comprising parameters stored in the at least one memory and trained to generate a part encoding based on a source image and a part image indicating a target part;
a condition encoder comprising parameters stored in the at least one memory and trained to generate a condition encoding based on the source image and pose information indicating a target pose; and
an image generation model comprising parameters stored in the at least one memory and trained to generate an output image that depicts an entity from the source image with the target pose or the target part based on the source image, the part encoding, and the condition encoding.

17. The apparatus of claim 16, further comprising:
a pose-warping mode configured to generate a pose-warped texture based on the source image and the pose information.

18. The apparatus of claim 16, further comprising:
a text encoder configured to generate a text encoding based on a text prompt.

19. The apparatus of claim 16, further comprising:
a pose detector configured to generate the pose information based on the source image.

20. The apparatus of claim 16, further comprising:
a segmentation model configured to generate the part image based on the source image.
